(19) United States
(12) Patent Application Publication
(10) Pub. No.: US 2026/0104144 A1
(43) Pub. Date: Apr. 16, 2026

(54) LIQUID AIR ENERGY CONVERSION SYSTEM AND METHOD

(71) Applicant: Henry E. Howard, Tonawanda, NY (US)

(72) Inventor: Henry E. Howard, Tonawanda, NY (US)

(21) Appl. No.: 19/274,931

(22) Filed: Jul. 21, 2025

Related U.S. Application Data
(60) Provisional application No. 63/705,679, filed on Oct. 10, 2024.

(51) Int. Cl. F17C 9/04; F01D 15/00; F25J 1/02

(52) U.S. Cl. CPC F17C 9/04; F01D 15/005; F25J 1/0242; F25J 2240/10; F25J 2240/90

(57) ABSTRACT

A liquid air energy conversion system is provided that integrates three subsystems or unit operations, namely a deep sub-ambient gas compression subsystem, a power expansion and heat recovery subsystem, and an external heat source.

### CROSS REFERENCE TO RELATED APPLICATIONS

This application claims the benefit of and priority to United States provisional patent application Ser. No. 63/705,679 filed on Oct. 10,2024 the disclosure of which is incorporated by reference.

### TECHNICAL FIELD

The present invention relates generally to liquid air energy conversion system and associated methods, and more particularly, to the integration of power generation cycles with liquid air energy conversion to produce electrical energy from liquid air energy storage systems.

### BACKGROUND

There is a continuing need to develop and demonstrate new energy storage and associated energy discharge systems and technologies that are both technically feasible and commercially viable. Such energy storage and discharge systems and technologies should have the capacity to discharge energy for a duration of greater than 10 hours at rated power and at a levelized cost of storage of about $0.05/kWh-cycle at some point in the near future. The targeted energy storage and discharge systems should be at a mega-watt scale. Moreover, new energy storage systems and technologies should be long duration storage systems able to supply power for weekly or monthly durations and have the capacity to continuously discharge energy on a daily or diurnal cycle for between 10 hours to 100 hours or more.

Liquid air energy storage (LAES) is a known technology that is well suited for longer duration, and greater power generation magnitude than can be achieved economically with lithium-ion batteries. The liquefaction of ambient air can be accomplished at high efficiency with known gas turbo-expansion based equipment and processes. However, the effective extraction of the energy contained or stored within the liquid air is a far more difficult challenge. Roughly 50% of the energy contained within liquid air is contained in the cryogenic, sub-ambient state. Conventional approaches to extraction and recovery of this energy from liquid air involve periodic heat exchange with cold stores (i.e. solids and liquids of high thermal capacitance) as generally disclosed in United States Patent Application Publications US2017/0022897 and US2023/0408188.

The cost and complexity of conventional LAES systems, including those that employ the use of cold stores, is relatively high and thus a barrier to widespread adoption and use LAES in the long duration energy storage market.

Unlike most other energy storage technologies, LAES systems often require mostly discrete and separate equipment for the charging step and the generating step, which represents a fundamental problem. To realize widespread adoption of LAES based systems, there must be a significant cost reduction of the LAES equipment or, more preferably, a step change in the extraction and recovery of energy from the liquid air.

Such step changes in the extraction and recovery of energy from the liquid air or the power discharge phase of LAES systems involves maximizing the potential power generated from liquid air by using energy from associated systems. One such approach would be integration of an external heat source with liquid air energy extraction such that the that discharge of power from stored liquid air may need to be essentially free of emissions.

To advance such an approach, there is a need to develop technically and economically viable processes which utilize available heat from external sources such that the that discharge of power from stored liquid air may need to be essentially free of emissions. In addition, the generation of heat from the combustion of a carbon-based fuels should also be minimized and preferably avoided to advance current “green” or “renewable” power initiatives for future electrical grid operations.

### SUMMARY

The present invention may be broadly characterized as an integrated liquid air energy conversion system comprising a deep sub-ambient gas compression subsystem, a power expansion and heat recovery subsystem, and an external heat source. The deep sub-ambient gas compression subsystem further comprises: (i) one or more liquid air pumps configured for receiving a liquid air stream and pressurizing the liquid air stream to a supercritical pressure yielding one or more supercritical liquid air streams; (ii) a main heat exchanger configured to vaporize the one or more supercritical liquid air streams via indirect heat exchange against the at least one low pressure cryogenic gas stream to yield the one or more very high pressure air streams and the one or more cooled low pressure cryogenic gas streams; and (iii) one or more compressors, including at least one cold compressor configured to compress the one or more cooled low pressure cryogenic gas streams to yield the one or more high pressure and/or very high pressure cryogenic gas streams. The power expansion and heat recovery subsystem further comprises: (iv) a heat recovery heat exchanger configured to warm the one or more very high pressure air streams via indirect heat exchange with the external heat source to yield a first warmed stream, and warm the one or more high pressure and/or very high pressure cryogenic gas streams via indirect heat exchange with the external heat source to yield a second warmed stream; (v) one or more turbine-expanders configured to expand the first warmed stream and the second warmed stream to produce the one or more exhaust streams and shaft work used to create the one or more sources of electrical power or to impart power to the one or more compressors. The deep sub-ambient gas compression subsystem and the power expansion and heat recovery subsystem are integrated such that a portion of the one or more exhaust streams is the source of low pressure cryogenic gas and the portion of the one or more exhaust streams is recycled from the power expansion and heat recovery subsystem to the deep sub-ambient gas compression subsystem.

The present invention may alternatively be characterized as a method of liquid air energy conversion comprising the steps of: (a) pressurizing a liquid air stream to a supercritical pressure yielding one or more supercritical liquid air streams; (b) vaporizing the one or more supercritical liquid air streams via indirect heat exchange against a low pressure cryogenic gas stream to yield one or more very high pressure air streams and one or more cooled, purified, low pressure cryogenic gas streams; (c) compressing the one or more cooled, purified, low pressure cryogenic gas streams in one or more compressors, including at least one cold compressor to yield one or more high pressure and/or very high pressure gas streams; (d) warming the one or more very high pressure air streams via indirect heat exchange with an external heat source to yield a first warmed stream; (e) warming the one or more high pressure and/or very high pressure cryogenic gas streams via indirect heat exchange with the external heat source to yield a second warmed stream; and (f) expanding the first warmed stream and the second warmed stream in one or more turbine-expanders to produce the one or more exhaust streams and shaft work used to create the one or more sources of electrical power; and (g) recycling all or a portion of the one or more exhaust streams as the low pressure cryogenic gas.

### BRIEF DESCRIPTION OF THE DRAWINGS

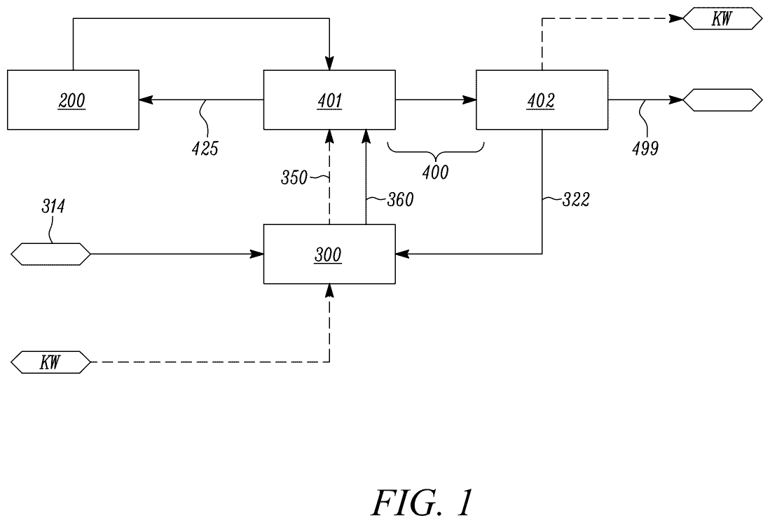

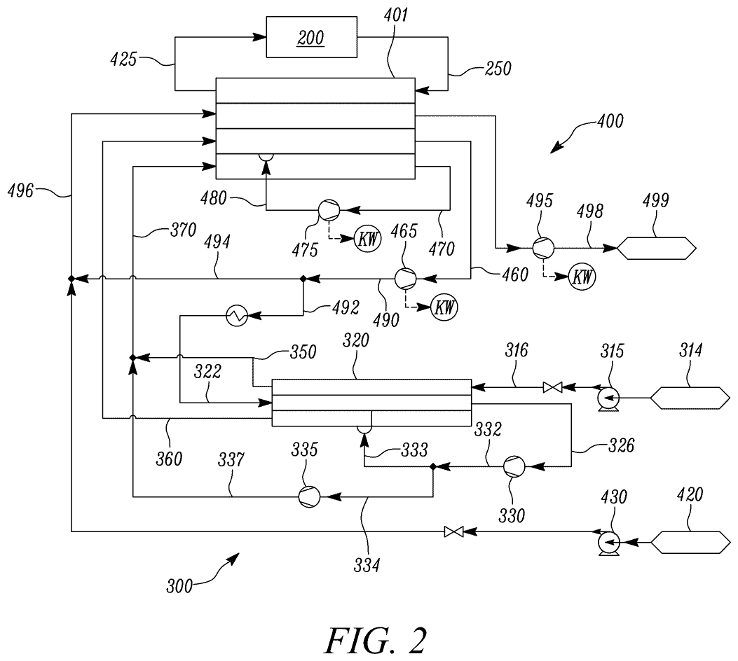

Aspects, features, and advantages of the present system and method will be more apparent from the following detailed description taken in conjunction with the drawings in which FIG. 1 is a high level overview of the present liquid air energy conversion system and method, and FIG. 2 is a more detailed schematic illustration of a preferred embodiment of the system and method depicted in FIG. 1.

### DETAILED DESCRIPTION

As used herein, the term or phrase ‘low pressure’ means a pressure near ambient, and more particularly at a pressure of 10 bar(a) or less whereas the term or phrase ‘moderate pressure’ refers to a pressure that might exist at the gas turbine inlet in a conventional gas turbine based power recovery section of the liquid air energy conversion system, and more particularly a pressure between 10 bar(a) to about 50 bar(a). Likewise, the term or phrase ‘high pressure’ refers to a pressure in the range of about 50 bar(a) and 75 bar(a) whereas the term or phrase. ‘very high pressure’s used herein refers to a pressure where the fluid is substantially supercritical, and in the case of liquid air energy conversion, preferably to a pressure greater than 75 bar(a).

From a definition standpoint the term or phrase ‘air’ and ‘air stream’ as used herein should be construed to mean an oxygen and nitrogen containing stream that has an oxygen concentration not less than 10%. However, the term or phrase ‘liquid air’ should be understood to include cryogenic liquids having a nitrogen content greater than or equal to 70%, so as to include liquified air as well as liquid nitrogen. Also, the term or phrase ‘cryogenic gas’being defined to mean a gas possessing a boiling point less than −150° C. or more broadly as a gas that would not condense as it is cooled by the warming supercritical air. Lastly, the term or phrase ‘cold compression’ generally means compression of a gas having an inlet temperature of −50° C. or lower.

This present system and method has been developed for purposes of improving the discharge of energy/power from a liquid air energy storage (LAES) facility. Processes for the high efficiency liquefaction of air (i.e. the charging phase) are well established. In contrast, effective processes for extracting the energy/power from liquefied air have not yet been fully established. The subject processes eliminate the conventional use of a “cold store” process while simultaneously extracting the maximum value from the sub-ambient thermal aspects of liquid air.

As shown in FIG. 1, the present system and method is broadly characterized as involving thermal integration of several subsystems or unit operations, namely a deep sub-ambient compression subsystem 300, and a power expansion and heat recovery subsystem 400, and an external heat source 200.

The deep sub-ambient compression subsystem 300 receives a source of liquid air 314, pumps the liquid air preferably to a supercritical pressure and vaporizes the supercritical liquid air via indirect heat exchange with the stream of low pressure cryogenic gas 322 received from the power expansion and heat recovery subsystem 400 to yield a very high pressure air stream 350 and a cooled, pre-purified, low pressure cryogenic gas stream. As described in more detail below, the cooled, low pressure cryogenic gas stream at a sub-ambient temperature is compressed in one or more compressors, including at least one cold compressor, to yield one or more high pressure and/or very high pressure gas streams. Power input (kw) is also required by the deep sub-ambient compression subsystem 300. (00016) Ideally, the very high pressure air stream 350 is deeply supercritical, preferably at a pressure of about 70 bar(a) or higher and is then directed to the power expansion and heat recovery subsystem 400. In addition, the one or more high pressure gas streams 360 (or moderate pressure gas streams) produced in the deep sub-ambient compression subsystem 300 are also directed to the power expansion and heat recovery subsystem 400.

The power expansion and heat recovery subsystem 400 receives the very high pressure air stream 350 as well as the one or more moderate pressure or high pressure 360 gas streams from the deep sub-ambient compression subsystem 300. In addition, the very high pressure air stream 350 and/or all of or a portion of the moderate pressure or high pressure gas stream 360 from the deep sub-ambient compression subsystem 300 are warmed using the heat from an external source 200 in a heat recovery heat exchanger section 401 of the power expansion and heat recovery subsystem 400 and then expanded in one or more turbine-expanders in the power expansion section 402 of the power expansion and heat recovery subsystem 400 to produce shaft work used to create sources of electrical power. The cooled heat transfer fluid stream 425 exits the heat exchanger section of the power expansion and heat recovery subsystem 400 and is recycled preferably back to the external heat source 200 where it is re-heated while a portion of the exhaust streams from the one or more turbine-expanders may be extracted from the system as an exit stream 499 and perhaps vented to the atmosphere. Preferably, the flow of the portion of the exit stream 499 is roughly equivalent to the flow of the original feed liquid air. Power output generated by the power expansion and heat recovery subsystem 400 greatly exceeds the combined power required by the deep sub-ambient compression subsystem 300.

The over-arching purpose of the illustrated system and method is to produce power from liquefied air. In this way, power stored during the charging phase of a LAES cycle can be productively released. To enhance the power producing objective, power is extracted in the form of compression energy. On a simple thermodynamic level, the power required to compress any gas is roughly proportionate to the temperature at which such compression occurs. In the present system and method compression of the cryogenic gas in the deep sub-ambient compression subsystem 300 is done with at least one cold compressor thus reducing the power intake compared to other liquid air energy recovery systems.

Turning now to FIG. 2, there is shown a more detailed process flow diagram (PFD) of one embodiment of the present system and method. Each of the three integrated subsystems, and more particularly, the external heat source 200, the deep sub-ambient compression subsystem 300, and the power expansion and heat recovery subsystem 400 in the illustrated embodiment are detailed in the paragraphs that follow.

### Deep Sub-Ambient Gas Compression

Liquid air from a low pressure storage tank 314 or other low pressure source of liquid air, is first pumped via one or more pumps 315 preferably to a supercritical pressure, and more preferably to a pressure of about 70 bar(a) or higher and then directed into multi-stream main heat exchanger 320 where it is vaporized and warmed to near ambient temperatures. Although shown as a single pump 315, the system may include multiple pumps arranged in a serial orientation or a parallel orientation. Vaporizing the pumped supercritical liquid air stream 316 in the main heat exchanger 320 is accomplished via indirect heat exchange against a low pressure cryogenic gas 322. A flow ratio between the pre-purified, low pressure cryogenic gas 322 and the supercritical liquid air stream 316 is about 2.0 which is required to vaporize substantially all of supercritical liquid air and yield a very high pressure air stream 350. The low pressure cryogenic gas 322 is substantially cooled to near saturation and the cooled low pressure cryogenic gas stream 326 is then directed to an initial cold compressor 330. The cooled low pressure cryogenic gas stream 326 is compressed to a moderate or high pressure of greater than about 5.0 times the pre-purified, low pressure cryogenic gas stream 322 to yield a moderate pressure or high pressure cryogenic gas stream 332, most preferably a moderate pressure cryogenic gas stream in the range of 15 bar(a) to 40 bar(a). The compression ratio of 5X is desirable from the standpoint of economical compression and the refrigeration needs at a warm end of main heat exchanger 320.

The flow of the low pressure cryogenic gas stream 322 is preferably designed or determined to achieve a close temperature approach of the cooling curves (i.e. about 2.0° C.) near the cold end of main heat exchanger 320. Such a flow rate of the low pressure cryogenic gas stream 322 results in potential thermal cross-over near the warm end of the main heat exchanger core. To resolve this, a small amount of supplemental warm end refrigeration is provided by diverting a first portion 333 of the moderate pressure or high pressure cryogenic gas stream back to an intermediate location of the main heat exchanger 320 and warm the diverted first portion 333 in the main heat exchanger 320 to near ambient temperature. The warmed first portion of the moderate pressure or high pressure cryogenic gas stream 360 is directed to the power expansion and heat recovery subsystem 400. The diverted first portion 333 of the cold compressed gas stream is preferably less than 40% by volume of the entire cold compressed gas stream 322, and more preferably less than 25% by volume of the entire cold compressed gas stream 322.

The remaining portion or second portion 334 of the moderate pressure or high pressure cryogenic gas stream is then further compressed in the auxiliary compressor 335 to a high pressure, or more preferably to very high pressure in excess of 70 bar(a). This further compressed gas stream 337 generally exits auxiliary compressor 335 near ambient temperature or a super-ambient temperature and may be combined with the warmed/vaporized very high pressure air stream 350 to create a combined very high pressure air stream 370 for purposes of sendout or distribution to the power generation and heat recovery subsystem 400. It should be noted that if the temperature of the further compressed gas stream 337 is below the warm end temperature of main heat exchanger 320, the compressed gas stream 337 may then be further warmed in main heat exchanger 320 and then combined with the warmed and vaporized very high pressure air stream 350.

In alternate embodiments of the present system and method, the deep sub-ambient compression subsystem 300 may be configured to direct portions of the high pressure or very high pressure gas stream 377 and the very high pressure air stream 350 separately to the power generation and heat recovery subsystem 400.

It should also be noted that the low pressure cryogenic gas 322 is preferably at a low pressure in the range of 2 bar(a) to 10 bar(a) and if necessary, can be pre-purified in a pre-purification unit prior to entry into the cryogenic deep sub-ambient gas compression subsystem 300. In alternate embodiments, the stream of low pressure, pre-purified cryogenic gas 322 may be a purified air stream at a pressure in the range of 2 bar(a) to 10 bar(a) originally sourced from a nearby air separation plant.

### Power Expansion and Heat Recovery

Turning back to FIG. 2, the combined very high pressure gas stream 370 derived from the deep sub-ambient gas compression subsystem 300 is directed to the power generation and heat recovery subsystem 400, and in particular to a heat recovery heat exchanger 401. The illustrated heat recovery heat exchanger 401 is configured to warm the combined very high pressure air stream 370 as well as the moderate pressure or high pressure cryogenic gas stream 360 via indirect heat exchange with a heat transfer fluid stream 250 originating from the external heat source 200. The warmed streams exit the main heat recovery heat exchanger at temperatures preferably higher than about 200° C. and even more preferably greater than about 400° C.

The illustrated embodiment of the power generation and heat recovery subsystem 400 incorporates at least two power expansion stages to produce electricity. The first power expansion stage involves expansion of the warmed, combined very high pressure gas stream 470 exiting the warm end of the heat recovery heat exchanger in a first turbine-expander 475 while the second power expansion stage involves expansion of a warmed moderate pressure or high pressure gas stream 460 exiting the warm end of the heat recovery heat exchanger 401 in a second turbine expander 465.

More specifically, the combined very high pressure gas stream 370 is substantially warmed within the heat recovery heat exchanger 401 to temperatures preferably greater than 400° C. The warmed very high pressure gas stream 470 is subsequently expanded in turbine-expander 475 to yield a moderate pressure or high pressure exhaust stream 480. The moderate pressure or high pressure exhaust stream 480 is then directed to an intermediate location of the heat recovery heat exchanger 401 where it is mixed with the moderate pressure or high pressure gas stream 360 from the deep sub-ambient compression subsystem 300 and warmed. The warmed, mixed stream exists the warm end of the heat recovery heat exchanger 401 as a warmed, moderate pressure or high pressure gas stream 460 also at a temperature preferably greater than 400° C. and is expanded in the second turbine-expander 465 to yield a low pressure exhaust stream 490.

A first portion of the low pressure exhaust stream 492 is optionally cooled and then recycled back to the deep sub-ambient compression subsystem 300 as the low pressure cryogenic gas 322. A second portion of the low pressure exhaust stream 494 is optionally hydrated with an external source of water 420 pumped via water pump 430 to yield a hydrated low pressure exhaust stream 496. The hydrated low pressure exhaust stream 496 is then warmed in the heat recovery heat exchanger 401. The resulting warmed, low pressure exhaust stream is then expanded in a third turbine expander 495 to produce a third exhaust stream 498 at a pressure nominally above ambient pressure and shaft work used to create a third source of electrical power. The third exhaust stream 498 may be vented to the atmosphere as exit stream 499.

The heat transfer fluid stream 250 originating from the external heat source 200 used to warm the combined very high pressure air stream 370, the moderate pressure or high pressure gas streams 360, and the low pressure exhaust stream 490 exits the cold end of the heat recovery heat exchanger 401 as cooled heat transfer fluid stream 425 and is recycled back to the external heat source 200 where it is re-heated.

### External Heat Source

The heat source contemplated for use in the present system and method has been assumed to be a fluid which transfers heat by way of indirect heat transfer. Such heat exchange may occur by way of indirect heat transfer (i.e. conductive or convective heating, sensible heat transfer, etc.) or by way of radiative heat transfer. Combinations of such external heating sources are also possible. Such heat may be transferred by way of an intermediary heat transfer fluid (e.g. a molten salt or a heat transfer fluid). Numerous possible heating sources exist and these include: energy from solar concentrators, the flue gas of an industrial process, solid/liquid heat stores generated by renewable power and low pressure steam or the use of thermal batteries that use renewable energy to heat up blocks, rocks or molten salt. The heat source may alternatively be electrical in nature such as those employed for the thermal cracking of hydrocarbons such as that described in US 2023/0407186.

### Alternative Embodiments

Although not shown, it is possible to eliminate the third turbine-expander and configure the second turbine-expander to produce an exhaust stream slightly above ambient pressure. After expansion in the second turbine-expander, the first portion of the low pressure exhaust stream is partially compressed and/or cooled as it is recycled back to the deep sub-ambient compression subsystem 300 as the low pressure cryogenic gas. The second portion of the low pressure exhaust stream can be vented to the atmosphere.

The above-described system and method may also be configured with several distributed air extraction points. In particular, the exit stream may be alternatively viewed as a feed gas for another process. For instance, a total flow of air roughly equivalent to the original liquid air flow may be extracted from any number of positions within the illustrated system. Such extracted air streams may be directed to a cryogenic air separation unit to produce oxygen, nitrogen and/or argon products in either liquid or gaseous form. A stream of air may also be extracted from the above-described system for purposes of feeding an existing gas turbine cycle. In such embodiment, the air stream would preferably be extracted from the exhaust of the first turbine-expander or the second turbine-expander.

Additional turbine-expanders may also be employed in this liquid air energy conversion process. For instance, the very high pressure air streams from the deep sub-ambient compression subsystem need not possess the same exiting pressure. Such streams may be warmed independently against the heat sources and expanded separately in lieu of forming the combined very high pressure stream. Such a configuration would likely be more capital intensive however would afford an additional degree of design freedom. Similarly, the moderate pressure air stream from the deep sub-ambient compression subsystem could be kept independent of the exhaust stream from the first turbine-expander. Such a stream could also be warmed and/or expanded separately.

As the exhaust streams from the one or more turbine-expanders will preferably be less than 300° C., it is conceivable to employ such exhaust streams for purposes of warming water, generating low pressure steam, and/or further preheating the streams exiting the deep sub-ambient compression subsystem.

Additional heat exchangers may be incorporated to the above-described system and process to perform such service.

Finally, although pre-purified air is the preferred cryogenic gas used in the deep sub-ambient compression subsystem, it is possible to configure the present system and method to enable the use of cryogenic fluids other than pre-purified air as the working fluid, such as liquid nitrogen or gaseous nitrogen as well as other mixtures of air constituents.

While the present system and method has been described with reference to certain embodiments, various changes may be made without departing from the spirit and the scope of the disclosure, which is defined, not by the detailed description and embodiments, but by the appended claims and their equivalents.

What is claimed is:

1. A liquid air energy conversion system comprising:
a source of low pressure cryogenic gas;
a source of liquid air;
a deep sub-ambient gas compression subsystem configured to: receive at least one stream of low pressure cryogenic gas from the source of low pressure cryogenic gas and a liquid air stream from the source of liquid air; pressurize the liquid air stream to a supercritical pressure yielding one or more supercritical liquid air streams; vaporize the one or more supercritical liquid air streams via indirect heat exchange against the at least one low pressure cryogenic gas stream to yield one or more very high pressure air streams and one or more cooled low pressure cryogenic gas streams; and compress the one or more cooled low pressure cryogenic gas streams to yield one or more high pressure and/or very high pressure cryogenic gas streams;
a power expansion and heat recovery subsystem configured to: warm all of or a portion of the one or more very high pressure air streams and warm the one or more high pressure and/or very high pressure cryogenic gas streams via indirect heat exchange with an external heat source to yield one or more warmed streams; and expand the one or more of the warmed streams in one or more turbine-expanders to produce one or more exhaust streams and shaft work used to create one or more sources of electrical power wherein a portion of the one or more exhaust streams is the source of low pressure cryogenic gas and the portion of the one or more exhaust streams is recycled from the power expansion and heat recovery subsystem to the deep sub-ambient gas compression subsystem.

2. The liquid air energy conversion system of claim 1, wherein the deep sub-ambient gas compression subsystem further comprises:
(i) one or more liquid air pumps configured for receiving the liquid air stream and pressurizing the liquid air stream to a supercritical pressure yielding one or more supercritical liquid air streams;
(ii) a main heat exchanger configured to vaporize the one or more supercritical liquid air streams via indirect heat exchange against the at least one low pressure cryogenic gas stream to yield the one or more very high pressure air streams and the one or more cooled low pressure cryogenic gas streams; and
(iii) one or more compressors, including at least one cold compressor configured to compress the one or more cooled low pressure cryogenic gas streams to yield the one or more high pressure and/or very high pressure cryogenic gas streams.

3. The liquid air energy conversion system of claim 2, wherein the power expansion and heat recovery subsystem further comprises;
(iv) a heat recovery heat exchanger configured to warm the one or more very high pressure air streams via indirect heat exchange with the external heat source to yield a first warmed stream, and warm the one or more high pressure and/or very high pressure cryogenic gas streams via indirect heat exchange with the external heat source to yield a second warmed stream;
(v) the one or more turbine-expanders configured to expand the first warmed stream and the second warmed stream to produce the one or more exhaust streams and shaft work used to create the one or more sources of electrical power or to impart power to the one or more compressors.

4. The liquid air energy conversion system of claim 4, wherein the cryogenic gas is a gas that has a normal boiling point equal to or less than −150 °C.

5. The liquid air energy conversion system of claim 4, wherein the at least one low pressure cryogenic gas is an air stream at a pressure in the range of 2 bar(a) to 10 bar(a).

6. The liquid air energy conversion system of claim 5 wherein the at least one low pressure cryogenic gas is a purified air stream at a pressure in the range of 2 bar(a) to 10 bar(a).

7. The liquid air energy conversion system of claim 3, wherein the one or more compressors of the deep sub-ambient compression subsystem further comprise:
the at least one cold compressor configured to compress the one or more cooled low pressure cryogenic gas streams to form a high pressure cold compressed gas stream; and
one or more auxiliary compressors configured to further compress all of or a portion of the high pressure cold compressed gas stream to yield one or more auxiliary discharge streams which form the one or more very high pressure gas streams.

8. The liquid air energy conversion system of claim 7, wherein a first portion of the high pressure cold compressed gas stream is directed to the main heat exchanger where it is warmed via indirect heat exchange against the low pressure cryogenic gas stream to yield the one or more high pressure gas streams.

9. The liquid air energy conversion system of claim 8, wherein a remaining portion of the high pressure cold compressed gas stream is directed to the one or more auxiliary compressors.

10. The liquid air energy conversion system of claim 9, wherein the first portion of the high pressure cold compressed gas stream is in the range of 20% to 50% by volume of the high pressure cold compressed gas stream.

11. The liquid air energy conversion system of claim 9, wherein the one or more the one or more very high pressure air streams are combined with the one or more auxiliary discharge streams to form a combined very high pressure gas stream.

12. The liquid air energy conversion system of claim 11, wherein the heat recovery heat exchanger is configured to warm the combined very high pressure gas stream via indirect heat exchange with the external heat source to yield the first warmed stream.

13. The liquid air energy conversion system of claim 12, wherein the one or more turbine-expanders further comprises a first turbine-expander configured to expand the first warmed stream to produce a first exhaust stream and shaft work used to create a first source of electrical power.

14. The liquid air energy conversion system of claim 13, wherein the one or more turbine-expanders further comprises a second turbine-expander configured to expand the second warmed stream to produce a second exhaust stream and shaft work used to create a second source of electrical power.

15. The liquid air energy conversion system of claim 14, wherein a portion of the second exhaust stream is a recycle stream that is diverted to the main heat exchanger as the source of low pressure cryogenic gas.

16. The liquid air energy conversion system of claim 15, wherein the one or more turbine-expanders further comprises a third turbine-expander configured to expand a remainder portion of the second exhaust stream to produce a third exhaust stream and shaft work used to create a third source of electrical power.

17. The liquid air energy conversion system of claim 16, further comprising one or more exit streams that are extracted from the power and heat recovery subsystem, and wherein a flow of the one or more exit streams is roughly equal to a flow of the one or more very high pressure air streams.

18. The liquid air energy conversion system of claim 17, wherein the one or more exit streams comprise all or a portion of the first exhaust stream, the second exhaust stream, or the third exhaust stream.

19. The liquid air energy conversion system of claim 17, wherein the one or more exit streams are vented to the atmosphere.

20. The liquid air energy conversion system of claim 16, wherein the first exhaust stream and the remainder portion of the second exhaust stream are warmed in the heat recovery heat exchanger via indirect heat exchange with the external heat source.

21. The liquid air energy conversion system of claim 16, wherein the one or more high pressure gas streams, the one or more very high pressure gas streams, the first exhaust stream and/or the remainder portion of the second exhaust stream are hydrated with a source of water.

22. A method of liquid air energy conversion comprising the steps of:
(a) pressurizing a liquid air stream to a supercritical pressure yielding one or more supercritical liquid air streams;
(b) vaporizing the one or more supercritical liquid air streams via indirect heat exchange against a low pressure cryogenic gas stream to yield one or more very high pressure air streams and one or more cooled, purified, low pressure cryogenic gas streams;
(c) compressing the one or more cooled, purified, low pressure cryogenic gas streams in one or more compressors, including at least one cold compressor to yield one or more high pressure and/or very high pressure gas streams;
(d) warming the one or more very high pressure air streams via indirect heat exchange with an external heat source to yield a first warmed stream;
(e) warming the one or more high pressure and/or very high pressure cryogenic gas streams via indirect heat exchange with the external heat source to yield a second warmed stream;
(f) expanding the first warmed stream and the second warmed stream in one or more turbine-expanders to produce the one or more exhaust streams and shaft work used to create the one or more sources of electrical power; and
(g) recycling all or a portion of the one or more exhaust streams as the low pressure cryogenic gas.
